(19) United States
(12) Patent Application Publication
(10) Pub. No.: US 2022/0385675 A1
(43) Pub. Date: Dec. 1, 2022

(54) SYSTEM AND METHODS FOR DETECTING MALWARE ADVERSARY AND CAMPAIGN IDENTIFICATION

(71) Applicant: Saudi Arabian Oil Company, Dhahran (SA)

(72) Inventors: Hamidullah S. Tora, Dhahran (SA); Faraj M. Alqahtani, Dammam (SA); Aminullah S. Tora, Dhahran (SA); Rayan M. Hassanain, Dhahran (SA)

(21) Appl. No.: 17/332,803

(22) Filed: May 27, 2021

(51) Int. Cl. H04L 29/06; G06N 5/04; G06N 20/20; G06N 5/00

(52) U.S. Cl. CPC H04L 63/1416; G06N 5/04; G06N 20/20; G06N 5/003

(57) ABSTRACT

Detection and identification of malware adversaries and campaigns comprises code which executes in a computer system. An artifact having a bytestream from a source is received and analyzed to extract indicators of comprise (IOCs). The extracted IOCs are correlated with data sets of an intelligence database that stores data regarding malware adversaries and campaigns. A normalized data set pertaining to the artifact, the extracted IOCs, and data received from the intelligence database is generated based on the correlating step. A trained machine learning algorithm executes to evaluate a measurement of a probability as to whether the analyzed artifact is attributable to a particular threat actor and a particular campaign. A system is also disclosed in which a processor defines modules to implement the application described herein.

### FIELD OF THE DISCLOSURE

The present invention relates to information technology (IT) security, and, more particularly, relates to a system and method for detecting and identifying malware adversaries and campaigns using a machine learning platform.

### BACKGROUND OF THE DISCLOSURE

Companies and institutions can experience sustained cyberattacks from various entities known collectively as “adversaries.” Owing to the various ways in which such adversaries can hide their identities, vary their attack techniques and use proxies, it is often not easy to determine whether a particular attack is ad hoc or is part of a campaign of attacks from a known adversary.

Attackers are opportunistic and can switch lure themes daily to align with news cycles. One recent example of such opportunism is seen in the use of the COVID-19 pandemic as a theme for cyberattacks. While it is believed that the overall volume of malware has been relatively consistent over time, adversaries have used worldwide concern over COVID-19 to socially engineer lures around collective anxiety and the flood of information associated with the pandemic. Such campaigns have been used for broadly targeting consumers, as well as specifically targeting essential industry sectors such as health care.

Microsoft™ has recently reported that they observed 16 different nation-state actors either targeting customers involved in the global COVID-19 response efforts or using the crisis in themed lures to expand credential theft and malware delivery tactics. These COVID-themed attacks targeted prominent governmental health care organizations in efforts to perform reconnaissance on their networks or people. Reportedly, academic and commercial organizations involved in vaccine research were also targeted.

Solutions for protecting institutions against such targeted attacks must evolve to match the sophistication of the threat actors. To the best of the inventors' knowledge, the solutions deployed thus far tend to be limited in scope and lack the flexibility and comprehensiveness to discover the threat patterns indicative of a malware campaign. It is with respect to these limitations of existing systems and methods that the inventor has directed his technical solution.

### SUMMARY OF THE DISCLOSURE

In accordance with one aspect of the disclosure, a non-transitory computer-readable medium comprises instructions which, when executed by a computer system, cause the computer system to carry out a method of detecting and identifying malware adversaries and campaigns. The method according to this aspect of the invention includes receiving an artifact having a bytestream from a source, analyzing the bytestream to extract indicators of comprise (IOCs), and correlating the extracted IOCs with data sets of an intelligence database that stores data regarding malware adversaries and campaigns. Based on the correlating, the method generates a normalized data set pertaining to the artifact, the extracted IOCs, and data received from the intelligence database. A trained machine learning algorithm executes to evaluate a measurement of a probability as to whether the analyzed artifact is attributable to a particular threat actor and a particular campaign.

In accordance with further aspects of the disclosure, a method as described above has the trained machine learning algorithm is a semi-supervised random forest algorithm. The method can further include instructions executed the computer system to cause the computer system to send a query to the intelligence database using the extracted indicators of comprise (IOCs) of the artifact prior to the correlating step. Separately or in addition, the method can further include instructions which, when executed by the computer system, cause the computer system to, after sending the query and prior to the correlating step, receive query results from the intelligence database and parse the query results to enable a correlation between the query results and the IOCs of the artifact.

A method in accordance with the any of the foregoing aspects of the disclosure can further include instructions which, when executed by the computer system, cause the computer system to vectorize the normalized data set prior to executing the machine learning algorithm. Separately or in addition, the method can further include comprising instructions which, when executed by a computer system, cause the computer system to determine a criticality of a malware campaign event as weighted based on specific threat actor, campaign, country of origin and type of malware.

In further aspects, methods consistent with this disclosure can the normalized data set vectorized using a plurality of vectorization techniques including direct vectorization, meta-enhanced vectorization and fuzzy vectorization. Separately or in addition, methods consistent with this disclosure can have the machine learning algorithm attribute percentages to the threat actors and campaigns based on input of data regarding known threat actors, campaigns, countries of origin, and generic tags.

In accordance with a further aspect of the present disclosure, a system for identifying and classifying malicious URLs is provided in which there are one or more processors having access to program instructions that, when executed, generate various modules, including: a queue module configured to receive a file including a potentially malicious URL from a source; a feature selector module configured to select features of interest to identifying URLs extracted from the file received by the queue module; a vectorizing module configured to generate vectorized feature data form the features selected by the feature selector module using a plurality of vectorization techniques; a feature generation module configured to generate URL data features with reduced dimensionality from the vectorized feature data using a plurality of autoencoding techniques; a model handler module configured to select an artificial intelligence/machine learning (AI/ML) model to analyze the URL data features with reduced dimensionality, to transmit the model for execution, and to receive the results of the execution of the selected AI/ML model; and a visualizer module configured to provide a rendering of results of the execution of the selected AI/ML model.

In accordance with another aspect of the present disclosure, another system for detecting and identifying malware adversaries and campaigns from an artifact is provided in which there are one or more processors having access to program instructions that, when executed, generate various modules, including a bytestream analyzer module configured analyzing a bytestream of the artifact to extract indicators of comprise (IOCs); a correlation module configured to correlate the extracted IOCs with data sets of an intelligence database that stores data regarding malware adversaries and campaigns and, based on the correlation, generating a normalized data set pertaining to the artifacts, the extracted IOCs, and data received from the intelligence database; and a machine learning module configured to execute a trained machine learning algorithm to evaluate a measurement of a probability as to whether the analyzed artifact is attributable to a particular threat actor and a particular campaign.

Systems consistent with the present disclosure can further have the trained machine learning algorithm executing a semi-supervised random forest algorithm. Separately or in addition, systems can be configured to have the correlation module send a query to the intelligence database using the extracted indicators of comprise (IOCs) of the artifact prior to the correlation. Separately or in addition, the Correlation module can be further configured to, after sending the query and prior to the correlating step, receive query results from the intelligence database and parse the query results to enable a correlation between the query results and the IOCs of the artifact.

In further aspects, systems can be configured to have the machine learning module further configured to (1) vectorize the normalized data set prior to executing the machine learning algorithm, (2) vectorize the normalized data set using a plurality of vectorization techniques including direct vectorization, meta-enhanced vectorization and fuzzy vectorization, (3) to attribute percentages to the threat actors and campaigns based on input of data regarding known threat actors, campaigns, countries of origin, and generic tags, (4) to determine a criticality of a malware campaign event as weighted based on specific threat actor, campaign, country of origin and type of malware, or (5) to implement any combination of actions in a particular configuration consistent with the disclosure.

### BRIEF DESCRIPTION OF THE DRAWINGS

FIG. 1 is a schematic block diagram of a system and method for detecting and identifying malware adversaries and campaigns according to an exemplary embodiment of the present disclosure.

FIG. 2 is a schematic flow diagram of an exemplary embodiment of a Byte-Stream Analyzer module according to the present disclosure.

FIG. 3 is a schematic block diagram of a vectorizer module that vectorizes data using multiple techniques according to an embodiment of the present disclosure.

FIG. 4 is a schematic block diagram of a cache according to an embodiment of the present disclosure.

### DETAILED DESCRIPTION OF CERTAIN EMBODIMENTS OF THE DISCLOSURE

Disclosed herein is a platform for statically and dynamically analyzing suspected malicious binaries by parsing and extracting uniquely relevant indicators of compromise (IOCs) that can be used to identify malicious adversary campaigns. The systems and methods correlate extracted IOCs to internal and external threat intelligence and use a series of machine learning models to associate the artifacts with known adversary campaigns. In some embodiments, a statistical index is generated that measures the relatedness to a suspected adversary and/or specific adversary campaigns. The platform provides several distinct state machine modules that perform tasks including bytestream analysis, routing, correlation and machine learning. These modules are interconnected with internal and/or external databases that enable the machine learning module to train so as to identify adversarial malware campaigns based on the most relevant data.

At the outset it is noted that the term “module”, used in the description and accompanying figures, is defined as program code and associated memory resources, that when read and executed by a computer processor, perform certain defined procedures. For example, a “vectorizer module” comprises program code that when executed by a computer processor, performs procedures related to vectorization of data.

An “adversary is an entity (institution, person or group of persons, automated program) that is known to conduct cyberattacks directed toward other entities.

A “campaign” is a concerted cyberattack on a specific entity by an adversary that lasts continuously or intermittently over a threshold duration of time. A campaign can be conducted over days, months or years.

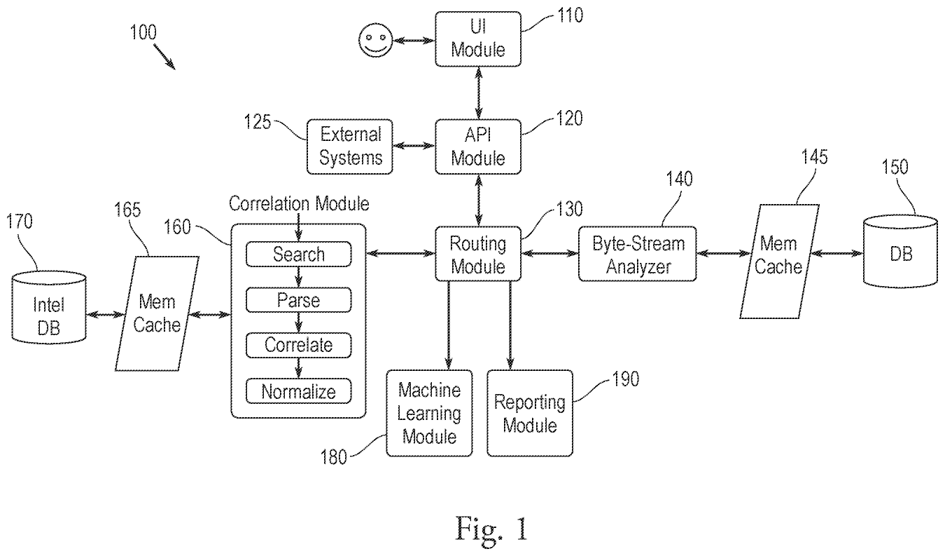

Referring to FIG. 1, a schematic block diagram of an exemplary embodiment of a system for detecting and identifying malware adversaries and campaigns is shown. System 100 comprises one or more computing devices having processors configured to execute a group of related program modules. System 100 is configured and arranged in separate state machine modules which can transmit data to each other as described below.

System 100 includes a user interface module (“UI module”) 110 provides a graphical user interface that enables users to interact with the system to process new submissions of potentially suspicious messages, files or other artifacts and to acquire relationships of the submitted artifacts to known adversaries and adversary campaigns. The UI module 110 also provides a search function that enables users to search for prior submissions using a natural language processing methodology for rapid search of historical datasets. The UI module 110 interacts with the other modules discussed below to provide users the ability to control and monitor correlations, visualizations, and to conduct data exploration. Visualizations of the resulting datasets can be rendered in various standard industry graphing approaches used in intelligence and data exploration. Additionally, the UI module 110 enables reporting, alerting, logging, and status of current jobs and processes.

The UI module 110 interacts (communicates data) directly with an application programming interface module 120 (“API module”). The API module 120 is comprised of a restful API that allows interfacing with the UI module 110 as well as a variety of input and output sources including, but not limited to, commercial security products, open-source solutions, and external direct analyst access for automation of various tasks. These are collectively referred to in FIG. 1 as external systems 125. The restful API is an architecture for an API that uses HTTP requests to access and use data. For example, reading, updating, creating and deleting can be performed through GET, PUT POST and DELETE methods. The API module 120 handles requests from the UI module 110 and performs search, submissions, job control requests, and all other requested functions. Requests and data are passed from the API module 120 to a Routing module 130 that performs routing, orchestration, job control, and status updates.

The Routing module 130 provides a central routing mechanism for requests and data between the API Module, and several other modules described further below. Additionally, it provides routing of datasets between modules, handles orchestration of the flow and steps between modules, handles job control and job status updates. The Routing module 130 also provides a central mechanism for receiving logs, updates, and results and can transmit the results to the API module 120 for use by the UI module 110, which generates a representation of the data and results to the user. Alternatively, the Routing module 130 can return results via API module 120 to external systems 125 such as security incident and event management (SIEM) systems, other third-party security solutions, and other external artificial intelligence and machine learning based solutions. The external systems 125 can utilize the results as part of routine, daily cybersecurity operations to defend organizations against malicious adversaries.

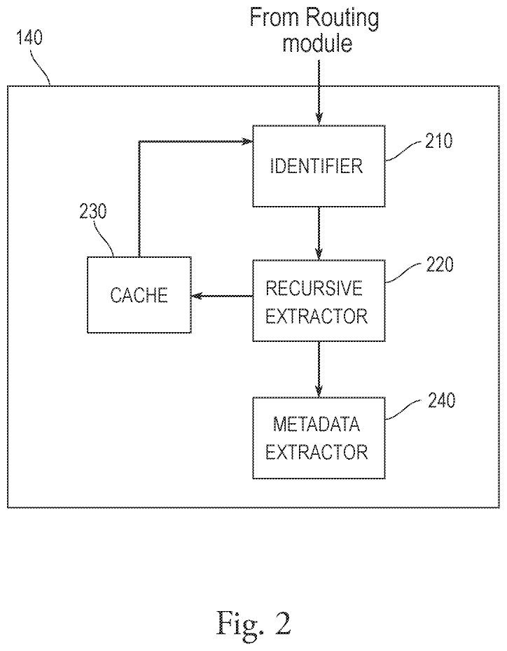

A Byte-Stream Analyzer module 140 interacts with the Routing module 130 and automates the process of submitting new files for analysis in order to extract relevant static content. An embodiment of the Byte-Stream Analyzer module is shown in FIG. 2. The Byte-Stream Analyzer module 140 includes an identifier module 210 that is configured to receive a file or other artifact provided via the Routing module from the UI module 110 or external system 125. The identifier module 210 is configured to parse the received artifact into a byte-stream and to initially identify the specific file type of the artifact. Additionally, the identifier module 210 can be configured to interrogate the artifact internally utilizing various methods such as byte-stream based “magic header” matching via tables of known file signatures, format indicators, machine and human linguistic syntax analysis to further analyze the file for various characteristics such as for strings (ASCII, Unicode, etc.) and further embedded artifacts. These techniques are used to further identify embedded files, objects, streams, human and machine language, general executable byte-code patterns, and random or encrypted byte patterns that can be present in a file artifact. Identifications can be stored in a memory cache 145 and released to a central intelligence database 150.

As embedded artifacts are identified, the artifact is passed to a recursive extractor 220 that extracts the embedded items from the artifact recursively. The recursive extractor 220 continues to break down the artifact into parts until all embedded portions have been extracted and no further meaningful data can be obtained from the original artifact (i.e., the artifact has been broken down into its minimal constituent elements). One way this can be determined is when an extraction step yields the same artifacts and data as a previous extraction step, indicating that no further data can be yielded from the artifact. As the items are extracted, they are passed through to a cache module 230 which performs lookups to determine if the embedded artifacts have been previously analyzed. If the lookup finds no match, the embedded artifacts are delivered back to the identifier module 210 to continue the same analysis process. Once each artifact (file, object, stream, byte-code patterns) is uniquely identified and reduced down to a non-reducible level, it is passed to a metadata extractor 240 that collects metadata available from each artifact such as string patterns, byte-code patterns, magic identifiers, author, creation timestamps, modification timestamps, programming language syntax identification, human language identification, URL's, emails, domains, IP addresses, MAC addresses, Geo-Location identifiers, phone numbers, physical addresses, etc. The artifacts and collected metadata are passed to memory cache 145 and stored in the central intelligence database 150. Once an artifact has been processed through the module 210, 220, 230, 240 of the Byte-Stream analyzer 140, the artifact, any embedded components and related metadata can be delivered back to the Routing module 130. The resulting intelligence and forensic artifacts are routed back to the Routing module 130 to be further processed by the Correlation module 160.

The Correlation module 160 is configured to communicate with an Intelligence database 170 via a second memory cache 165, with the Routing module 130, and with the Byte-Stream Analyzer module 140 via the Routing module. The Correlation module 160 forms queries in order to search the Intelligence database 170 for any information related to artifacts and metadata received from the Byte-Stream Analyzer module 140. Information returned from the Intelligence database is parsed, correlated with the incoming data from the Byte-Stream Analyzer module and normalized. As indicated in FIG. 1, the functions of searching, parsing, correlating and normalizing can be performed by distinct sub-modules, although the system is not limited in this way. The results of the correlation and normalization are converted into a malware adversary dataset for ingestion by a Machine Learning module 180.

The Correlation module 160 is configured with the capability to remove duplicates such as similar threat actors, campaigns, countries of origin, and other generic tags of interest from the database 170. This is a significant feature because several threat intelligence sources might have different names for the same threat actors. Also, in some cases, the same artifact may have been used by multiple threat actors. In cases such as these, the Correlation module 160 is enabled to dedupe and normalize the threat intelligence feeds. The Correlation module can also interpret insertions for new artifacts to the resulting data set. In this manner, the Correlation module can take as input four (4) parameters: threat actors, campaigns, countries of origin, and other generic tags. The data set is normalized and indexed to provide faster searching capabilities by use of the other modules.

The Machine Learning module 180 receives the resulting intelligence and forensic artifacts and performs parsing, feature extraction, and vectorization on the data. These steps render the data into a form more suited for input into various Machine Learning models. The Machine Learning module 180 is configured to select data sets or data points from within the newly collected data sets obtained from the Correlation module 160 and to establish a sub-set of data sets or data points for vectorization.

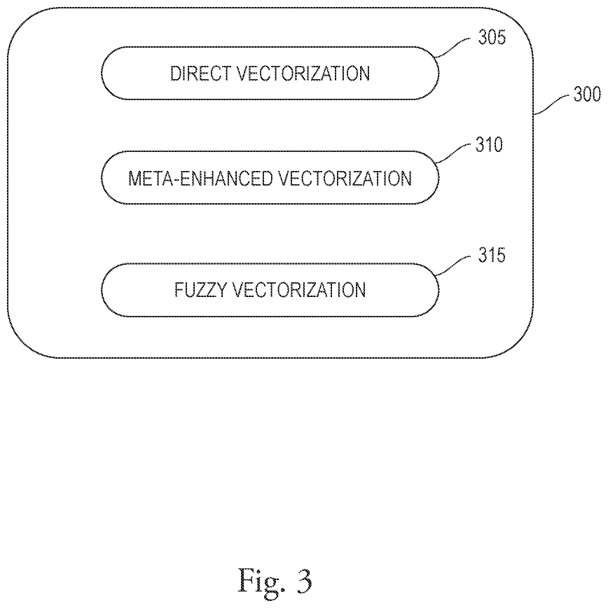

In some embodiments, the Machine Learning module 180 includes a vectorization submodule that performs vectorization of the data according to a plurality of different techniques to form varied vectorized data sets. FIG. 3 shows an embodiment of a vectorization submodule 300. As depicted, the vectorizer module 300 executes three different vectorization methods (sub-modules) direct vectorization 305, meta-enhanced vectorization 310, and fuzzy vectorization 315 to convert the data sets or data points into vectorized data sets or data points for proper ingestion and computation. Direct vectorization is a direct mapping of the specific byte values of each character of an artifact (e.g., a URL) from a text, UTF-8 or UTF-16 based value into a vector as normally defined in frameworks such as Tensorflow or MXNet. Metadata can include the URL current resolved IP address, autonomous system number (AS), hosting provider, domain owner, top-level domain, HTTPS certification metadata, for instance.

In meta-enhanced vectorization, meta-data can be combined with the regular data as part of the vectorization. Meta-enhanced vectorization can be performed in different modes. For example, in a brute force mode, all permutations of the transformed bytes from the artifact and all associated meta-data are permuted across to generate all possible vectorizations that are possible. In a set specific mode, a specific set of selected meta-data, the byte lengths of the selected metadata, and the mode of the permutation are selected by the operator. Fuzzy vectorization is a derivative of the meta-enhanced vectorization in which additional intelligence data is looked up and related to the artifact. All associated meta-data used to identify potential artifacts with the same domain, IP, owner, AS, etc. that may have had malicious activities within a set period of time in the past can be added to the vectorization utilizing the configurations set in the same manner as brute force or set specific as noted above.

The different vectorization methods can be executed simultaneously or in series, and the vectorizer module 300 can be configured to execute all of the method or only a subset of them depending on operator input. All vectorizations can be stored in the central database 150 and made available for analysis by following modules, by operators and more generally for future correlations and analyses.

Returning to FIG. 1, the Machine Learning module 180 further utilizes machine learning models to statistically associate the resulting data set and submitted binaries to the most likely adversary and also to a specific campaign of the most likely adversary depending upon the amount of information available regarding the specific campaigns. The Machine Learning module analyzes the dataset in terms of indicators of compromise (IOCs) which can be given a percentage as a measure of certainty. The Machine Learning module 180 selects model algorithms and determines specific structures and parameters to test the malware adversary data sets. Operator-set configurations specify which machine learning approaches are to be used and also whether the model approach will use new, untrained models or pre-trained models (which can then be retrained and tested). The operator can enable all approach selections or a subset of approaches. It is noted that the Machine Learning module 180 can select a model for training based on one or more data sets from the source data or alternatively, can select a trained model for execution to assess the data set for IOCs related to specific adversaries and campaigns.

The Machine Learning module 180 also choses the optimizer which can include gradient decent and its variants such as batch gradient descent, ADAM optimization, and second-order optimizers. Structural features can include the number of layers (regular and hidden) in a neural network, and the types and number of activations of each layer, the optimization algorithm employs hyperparameters which include such features as the learning rate, number of epochs (loops of optimization), training data batch size, type and weighting of regularization, among others. All of these configuration and parameters can be selected and updated by operators of the system and then implemented by executing code associated with the Machine Learning module 180 which code configures the model handler to select a model to test the malware adversary data set. Each module is designed to receive as input configuration parameters as defined per session or project that the analyst is investigating. The configuration parameters are grouped for vectorizers, feature generators, models, and training/testing. Each module uses the configuration parameters to determine selections for use, including mode, mixture of selections, and variations (i.e., of vectorizing and feature generation techniques, and machine learning model). The configuration parameters also determine when a model passes (successfully meets a threshold) or runs out of time. Configuration parameters are stored as JSON (JavaScript Object Notation) objects for each project or session. In general, the configuration parameters provide guidance and limits as to the approach taken by each module in succession in order to limit the extent of resources being utilized.

The Machine Learning module 180 can be configured to select model structures and hyperparameters according to different modes. In a brute force mode, the handler permutes across a set range of all possible values appropriate to each selected model. In a second mode, a range is preselected, and the model handler selects only values from within the set range of values for model hyperparameters, structure, layers, etc. per each machine learning approach and selected models. In addition, a time limit for model evaluation can be set by the operator, which limits the computations of the possible structure and hyperparameter values. The operator can select among the values computed prior to the time limit. The values are dependent on the machine learning approach taken, such as a semi-supervised random forest algorithm, Bayesian, Multi-Variate Bayesian, KNN, SVM, and many others within the Deep Learning approaches.

In some embodiments, models can comprise “supervised” or “semi-supervised” machine learning algorithms (or combinations thereof). Such machine learning algorithms employ forward and backward propagation, a loss function and an optimization algorithm such as gradient descent to train a classifier. In each iteration of the optimization algorithm on training data, outputs based on estimated feature weights are propagated forward and the output is compared with data that has been classified (i.e., which has been identified by type). The estimated weights are and then modified during backward propagation based on the difference between the output and the tagged classification as a function of the code used to implement this aspect of the ML algorithm. This occurs continually until the weights are optimized for the training data. Generally, the machine learning algorithm is supervised meaning that it uses human-tagged or classified data as a basis from which to train. However, in a prefatory stage, a non-supervised classification algorithm can be employed for initial classification as well.

The machine learning model(s) can be executed either locally or remotely (e.g., in a cloud-based system). The Machine Learning module 180 analyzes the results of execution of the model and determines if the training meets threshold criteria configurable by the operator. The threshold criteria typically pertains to the measured accuracy of a model in classifying the IOCs of the data set with a known adversary or campaign. If the training does not meet the set criteria (i.e., is not sufficiently accurate), the Machine Learning module can initiate an additional round of feature extraction. Alternatively, if the threshold criteria are met, the Machine Learning module 180 can accept the results and deliver them onward for output and monitoring. Over time, the Machine Learning module 180 can generate numerous different models to train, and the results of the different models can be analyzed and compared.

More specifically, the testing can involve evaluating whether the model's results meet the criteria to be declared a useful or successful model. These are based on accuracy, balanced accuracy, precision, recall, and variations of the confusion matrix. Variations of the confusion matrix can include Mathew's Correlation Coefficient (MCC), True Positive/Negative rates, Precision Positive/Negative Predictive rates, Fowlkes-Mallow index, informedness, markedness (delta-p), etc. and models with the highest ratings, based on metrics set by the operator are deemed useful or successful models. Models with the highest ratings or top-n models can be configured to be selected as the “winner” models.

After the models are executed and analyzed, the output of the Machine Learning module 180 is returned to the Routing Module 130 for updates and further processing and reporting by a Reporting Module 190. The Reporting module 190 is configured to receive results generated by the models of the Machine Learning module 180, to convert the results into various text and graphical formats according to preset selections, and to analyze the results for generation of alerts, dashboards, analysis reports, and communications (e.g., emails). The alerts, communications and other output re sent to analysts, system administrators, or external systems via the Routing module 130 and API module 120.

The Reporting module 190 is configured generate reports in various formats (PDF, JSON, XML, etc.) and can subsequently generate alerts that will be forwarded to a Security Orchestration, Automation, & Response (SOAR) platform, Security Information and Event Management (STEM) platform or a centralized Log Server. The Reporting module 190 verifies if the input it receives was system-generated or manually-triggered by an analyst via the UI module 110. For system-generated inputs, the Reporting module 190 performs a criticality check on the triggering event. The criticality is weighted based on specific threat actor(s), and/or a campaign(s) and countries of origin and the type of malware and its associated risk score. For highly critical events, all analysts and system administrators are notified. For all other alert status, the incident is assigned to an analyst for further investigation (e.g., in a round-robin manner). Both UI and system-generated interactions are added to the default Adversary Campaign dashboards to maintain a list of all recent artifact attributions to adversaries and campaigns along with their subsequent relationship percentages.

As noted previously, the Routing Module 130 provides a central routing mechanism for requests and data between the API Module 120, Byte-Stream Analyzer module 140, Correlation Module 160, Machine Learning Module 180, and Reporting Module 190. Additionally, the Routing module 130 provides routing of the datasets between modules, handles orchestration of the flow and steps between modules, handles job control and job status updates, and provides a central mechanism to receive logs, updates, and results from the Reporting module 190 to be sent back to the API module 120 for use by the UI module 110 to represent the data and results to the user, or to be returned via API to external systems such as security incident and event management (SIEM) systems, and other external artificial intelligence and machine learning based solutions.

All of the aforementioned modules generate logs, events, and alerts using configured logging functionality. The logs provide access control, health monitoring, and auditing of the overall system. The logs can be routinely returned to the Routing Module 130 and then routed back to the API Module to provide status and data back to external systems and the UI module.

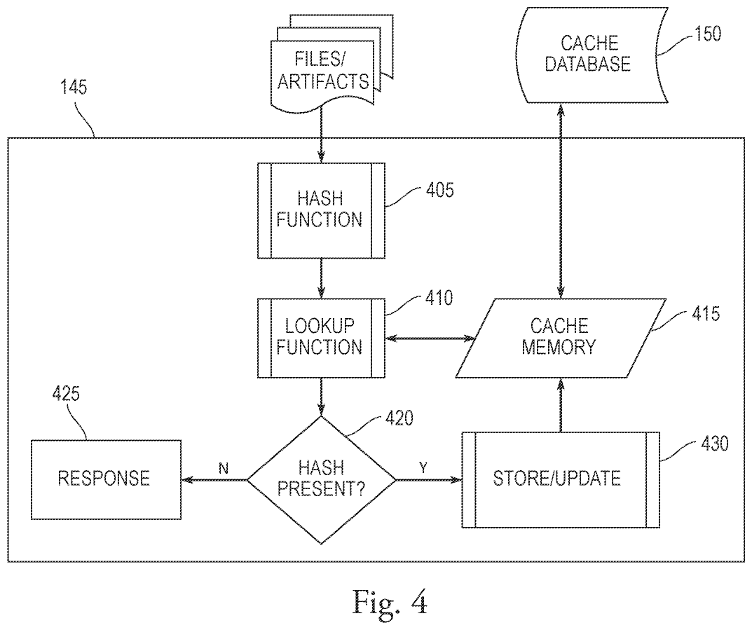

The memory caches e.g., 145, 165 used in the system 100 can be used to avoid redundancy by checking whether new input data has been reviewed before. FIG. 4 is a schematic flow diagram of an exemplary embodiment of the flow of functions performed by a memory cache according to the present disclosure. As shown, data received by a cache is input to a hash function 405, which can be a standard hash function well-known in the art such as MD5, SHA1, SHA2. The hash is passed to a lookup function 410 which access cache memory 415 to determine if the hash has been generated previously. In some implementations, the memory cache can periodically load data to a central database 150. If it is determined from the results of the lookup function that the hash is already present (flow element 425), e.g., due to a match with data in a memory or database, a response procedure 430 automatically generates a notification which can be passed to system operators. The notification can include text or other codes to inform the operators the ingested artifact has already been analyzed by the forensic system. If it is determined that the hash is new, e.g., due to there not being a match within at least a prescribed tolerance, the hash is stored 435 and the memory cache is updated with an entry of the new hash.

It should be understood that all of the system components described herein such as collector nodes, analysis modules, etc. are embodied using computer hardware (microprocessors, parallel processors, solid-state memory or other memory, etc.), firmware and software as understood by those of skill in the art and can include servers, workstations, mobile computing devices, as well as associated networking and storage devices. Communications between devices can occur over wired or wireless communication media and according to any suitable communications system or protocol.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A non-transitory computer-readable medium comprising instructions which, when executed by a computer system, cause the computer system to carry out a method of detecting and identifying malware adversaries and campaigns, the method including steps of:
receiving an artifact having a bytestream from a source;
analyzing the bytestream to extract indicators of comprise (IOCs);
correlating the extracted IOCs with data sets of an intelligence database that stores data regarding malware adversaries and campaigns;
based on the correlating step, generating a normalized data set pertaining to the artifact, the extracted IOCs, and data received from the intelligence database; and
executing a trained machine learning algorithm to evaluate a measurement of a probability as to whether the analyzed artifact is attributable to a particular threat actor and a particular campaign.

2. The non-transitory computer-readable medium of claim 1, wherein the trained machine learning algorithm is a semi-supervised random forest algorithm.

3. The non-transitory computer-readable medium of claim 1, further comprising instructions which, when executed by the computer system, cause the computer system to send a query to the intelligence database using the extracted indicators of comprise (IOCs) of the artifact prior to the correlating step.

4. The non-transitory computer-readable medium of claim 3, further comprising instructions which, when executed by the computer system, cause the computer system to, after sending the query and prior to the correlating step, receive query results from the intelligence database and parse the query results to enable a correlation between the query results and the IOCs of the artifact.

5. The non-transitory computer readable medium of claim 1, further comprising instructions which, when executed by the computer system, cause the computer system to vectorize the normalized data set prior to executing the machine learning algorithm.

6. The non-transitory computer-readable medium of claim 5, wherein the normalized data set is vectorized using a plurality of vectorization techniques including direct vectorization, meta-enhanced vectorization and fuzzy vectorization.

7. The non-transitory computer-readable medium of claim 1, wherein the machine learning algorithm attributes percentages to the threat actors and campaigns based on input of data regarding known threat actors, campaigns, countries of origin, and generic tags.

8. The non-transitory computer-readable medium of claim 1, further comprising instructions which, when executed by the computer system, cause the computer system to determine a criticality of a malware campaign event as weighted based on specific threat actor, campaign, country of origin and type of malware.

9. A system for identifying and classifying malicious URLs comprising:
one or more processors, the processors having access to program instructions that when executed, generate the following modules:
a queue module configured to receive a file including a potentially malicious URL from a source;
a feature selector module configured to select features of interest to identifying URLs extracted from the file received by the queue module;
a vectorizing module configured to generate vectorized feature data form the features selected by the feature selector module using a plurality of vectorization techniques;
a feature generation module configured to generate URL data features with reduced dimensionality from the vectorized feature data using a plurality of autoencoding techniques;
a model handler module configured to select an artificial intelligence/machine learning (AI/ML) model to analyze the URL data features with reduced dimensionality, to transmit the model for execution, and to receive the results of the execution of the selected AI/ML model; and
a visualizer module configured to provide a rendering of results of the execution of the selected AI/ML model.

10. A system for detecting and identifying malware adversaries and campaigns from an artifact comprising:
one or more processors, the processors having access to program instructions that when executed, generate the following modules:
a bytestream analyzer module configured analyzing a bytestream of the artifact to extract indicators of comprise (IOCs);
a correlation module configured to correlate the extracted IOCs with data sets of an intelligence database that stores data regarding malware adversaries and campaigns and, based on the correlation, generating a normalized data set pertaining to the artifacts, the extracted IOCs, and data received from the intelligence database; and
a machine learning module configured to execute a trained machine learning algorithm to evaluate a measurement of a probability as to whether the analyzed artifact is attributable to a particular threat actor and a particular campaign.

11. The system of claim 10, wherein the trained machine learning algorithm executed by the machine learning module is a semi-supervised random forest algorithm.

12. The system of claim 10, wherein the correlation module is further configured to send a query to the intelligence database using the extracted indicators of comprise (IOCs) of the artifact prior to the correlation.

13. The system of claim 12, wherein the Correlation module is further configured to, after sending the query and prior to the correlating step, receive query results from the intelligence database and parse the query results to enable a correlation between the query results and the IOCs of the artifact.

14. The system of claim 10, wherein the Machine Learning module is further configured to vectorize the normalized data set prior to executing the machine learning algorithm.

15. The system of claim 15, wherein the machine learning module is further configured to vectorize the normalized data set using a plurality of vectorization techniques including direct vectorization, meta-enhanced vectorization and fuzzy vectorization.

16. The system of claim 10, wherein the machine learning algorithm attributes percentages to the threat actors and campaigns based on input of data regarding known threat actors, campaigns, countries of origin, and generic tags.

17. The non-transitory system of claim 10, wherein the machine learning module is further configured to determine a criticality of a malware campaign event as weighted based on specific threat actor, campaign, country of origin and type of malware
